(19) United States
(12) Patent Application Publication
(10) Pub. No.: US 2014/0167377 A1
(43) Pub. Date: Jun. 19, 2014

(54) KINGPIN DRIVER

(71) Applicant: KENNETH HOELSHER, Palmyra, MO (US)

(72) Inventor: KENNETH HOELSHER, Palmyra, MO (US)

(21) Appl. No.: 13/718,469

(22) Filed: Dec. 18, 2012

(51) Int. Cl. B62D 7/18

(52) U.S. Cl. CPC B62D 7/18
USPC 280/93.512

(57) ABSTRACT

A kingpin driver comprising a first cap, where the first cap includes an opening; a second cap positioned at an opposing side of the kingpin driver, where the second cap includes an opening, and where the second cap comprises a larger circumference than the first cap; a plurality of connection rods positioned between the first cap and the second cap, where the plurality of connection rods fastens the first cap and the second cap; and a driving mechanism, where the driving mechanism threads through the opening of the first cap and the opening of the second cap to drive out a kingpin when the kingpin driver is position within a spindle.

### BACKGROUND OF THE INVENTION

1. Field of the Invention

The present invention relates to a tool used by truck drivers to assist them when mounting the axles to the main pivot in a steering device of a truck.

2. Description of Related Art

Vehicles include a suspension system that cushions and evens out the bumps on the road to maintain a smooth ride. Without the suspension system the vehicle's ride would be very uncomfortable and dangerous. The suspension systems typically utilize springs to absorb the bumps and movement exerted on the vehicle. Joined to the suspension system is a kingpin or spindle bolt which is the main pivot in the steering mechanism of the vehicle. The kingpins allow for carrying of very heavy weight which is useful for hauling, specifically in large trucks and trailers.

Typically, when repairs are needed on the suspension system the kingpin must be removed to work on other areas of the system. Removal of the kingpin may be a laborious, time consuming and even costly procedure because of its positioning within the spindle. It is often difficult to remove the kingpin without damaging the surrounding components of the suspension system. For example, people find that after they remove the kingpin that the threads on the spindle are damaged. This is due to the difficulty many mechanics face in keeping their hands away from the driver when mounting the axles to the main pivot of the steering device.

It would be beneficial in the art to provide a tool that assists a mechanic to easily remove a kingpin without damaging the surrounding parts. It would also be desirable for the tool to prevent damage to the user's hand when driving out the kingpin.

### SUMMARY OF THE INVENTION

In view of the foregoing disadvantages inherent in the prior art, the general purpose of the present invention is to provide a tool to drive out a kingpin, configured to include all of the advantages of the prior art, and to overcome the drawbacks inherent therein.

Accordingly, an object of the present invention is to provide a tool which drives out a kingpin by threading the tool into a spindle, and then striking a driving mechanism positioned within the tool and atop the kingpin to drive the kingpin through the spindle.

Another object of the present invention is to provide two different sized caps within the same tool to provide better fittings for kingpin removal thereby preventing injury to surrounding spindle or the user.

To achieve the above objects, in an aspect of the present invention, a kingpin driver is described comprising a first cap, where the first cap includes an opening; a second cap positioned at an opposing side of the kingpin driver, where the second cap includes an opening, and where the second cap comprises a larger circumference than the first cap; a plurality of connection rods positioned between the first cap and the second cap, where the plurality of connection rods fastens the first cap and the second cap; and a driving mechanism, where the driving mechanism threads through the opening of the first cap and the opening of the second cap to drive out a kingpin when the kingpin driver is position within a spindle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a kingpin driver in accordance with an exemplary embodiment of the present invention.

### DETAILED DESCRIPTION OF THE DRAWINGS

The present invention relates to a tool used by truck drivers to assist them when mounting the axles to the main pivot in a steering device of a truck. The present invention provides a kingpin driver to allow for easier removal of a kingpin from a spindle. The kingpin driver is comprised of two cap connected with a plurality of rods. The caps serve to align a driving mechanism through the kingpin driver to remove a kingpin or spindle bolt. By threading the kingpin driver into the spindle the threads on the spindle are protected from damaged by ensuring that the kingpin is removed easily without hitting the walls of the spindle. Additionally, the kingpin driver allows the user to keep their hands away from the hammer striking the driving mechanism.

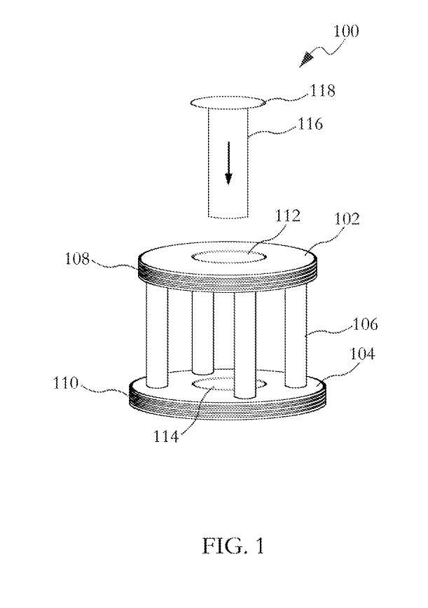

Turning now descriptively to the drawing, referring to FIG. 1, a perspective view of a kingpin driver 100 is shown in accordance with an exemplary embodiment of the present invention. The kingpin driver 100 includes two caps, a first cap 102 positioned on a top portion of the kingpin driver 100, and an opposing second cap 104 positioned on a bottom portion. The first cap 102 comprises a smaller circumference than the second cap 104. The first cap 102 and the second cap 104 are attached to each other with a plurality of rods 106. The connection rods 106 may be multiple bolts that are welded radially to each cap to ensure a permanent and durable attachment. The kingpin driver 100 is made from metal and comprises a length of 6-8 inches.

The first cap 102 and the second cap 104 are circular structures each with threading around the circumferential outer surfaces 108, 110. The first cap 102 includes an outer surface 108, and the second cap 104 also includes an outer surface 110. The first cap 102 includes a circular opening 112 that is aligned with a circular opening 114 within the second cap 104. The circular openings 112, 114 are the same size to receive a driving mechanism 116 or punch. The driving mechanism 116 includes a top disc 118 that endures the impact of a driving mechanism or hammer when using the kingpin driver 100.

During use, the appropriate cap that best fits within the desired spindle is threaded into the spindle with the cap positioned on the bottom resting above the kingpin. Next the user aligns the driving mechanism within the openings until the bottom of the punch reaches the kingpin. The user then strikes the top disc of the driving mechanism thereby striking the kingpin. The user continues to strike the driving mechanism until the kingpin is removed from the spindle. By utilizing the kingpin driver, the user is able to more easily remove a kingpin without damaging the inside of the spindle or damaging their own hand or fingers.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A kingpin driver comprising:
a. a first cap, where the first cap includes an opening;
b. a second cap positioned at an opposing side of the kingpin driver, where the second cap includes an opening, and where the second cap comprises a larger circumference than the first cap;
c. a plurality of connection rods positioned between the first cap and the second cap, where the plurality of connection rods fastens the first cap and the second cap; and
d. a driving mechanism, where the driving mechanism threads through the opening of the first cap and the opening of the second cap to drive out a kingpin when the kingpin driver is position within a spindle.

2. The kingpin driver according to claim 1, where the plurality connection rods is welded to each the first cap and the second cap.

3. The kingpin driver according to claim 1, where the first cap and the second cap are circular.

4. The kingpin driver according to claim 1, where the first cap and the second cap include threaded circumferential outer surfaces.

5. A method of use for a kingpin driver comprising the steps of:
a. aligning an appropriate size cap atop a kingpin within a spindle, where the appropriate size cap best fits within the spindle and is selected from a first cap and a second cap, where the first cap is smaller than the second cap;
b. screwing in the appropriate size cap within the spindle;
c. striking a driving mechanism that fits through a pair of holes, one in each the first cap and the second cap, where the driving mechanism strikes the kingpin; and
d. driving out the kingpin by continuing to strike the driving mechanism.

6. The method of use for the kingpin driver according to claim 5 further comprising the step of exchanging the opposing cap against the kingpin when a larger spindle is used.
